(19) United States
(12) Patent Application Publication
(10) Pub. No.: US 2019/0304483 A1
(43) Pub. Date: Oct. 3, 2019

(54) USING SELECTED GROUPS OF USERS FOR AUDIO ENHANCEMENT

(71) Applicant: Axwave, Inc., Menlo Park, CA (US)

(72) Inventors: Damian Scavo, Menlo Park, CA (US); Loris D'Acunto, Palo Alto, CA (US); Fernando Flores, New York, NY (US)

(21) Appl. No.: 16/147,194

(22) Filed: Sep. 28, 2018

Related U.S. Application Data
(60) Provisional application No. 62/566,209, filed on Sep. 29, 2017.

(51) Int. Cl. G10L 25/51; G06F 3/16

(52) U.S. Cl. CPC G10L 25/51; G06F 3/167

(57) ABSTRACT

A computer-implemented method includes providing an online mobile application to a plurality of users being selected based on one or more qualifications or associations, receiving a recorded audio signal recorded through an interface associated with the mobile application, adding metadata through the mobile application, and detecting a type of content or media associated with the received recorded audio signal and adding additional metadata based on a content type associated with a metadata structure, to provide a rich result dataset with different tagged content and metadata structures.

This application claims priority under 35 U.S.C. 119(a) to U.S. Provisional Application No. 62/566,209, filed on Sep. 29, 2017, the content of which is incorporated herein in its entirety for all purposes.

### BACKGROUND

### 1. Technical Field

An objective of the example implementations is to provide a way to generate a data-rich audio database using tagged audio signals and iterative learning processes.

### 2. Related Art

### SUMMARY

An objective of the example implementations is to provide a distributed client-server platform in which groups of users contribute to the generation of audio databases for different types of media content such as feature-length movies, music, television series, or advertisement spots.

A computer-implemented method is provided herein. This method comprises providing an online mobile application to users that are selected based on one or more qualifications or associations of the users. A recorded audio signal is received via an interface (e.g., microphone) associated with the mobile application. This mobile application is configured to add metadata to the recorded audio signal and to provide the recorded audio signal with the added metadata to a server. At the server, a type of content or media associated with the received recorded audio signal having the added metadata is detected. Additional metadata received from the mobile application is then added, based on the type of content or media associated with the received recorded audio signal having the added metadata. This type of content or media associated with the received audio signal having the added metadata is associated with a metadata structure.

### BRIEF DESCRIPTION OF THE DRAWINGS

FIG. 1 illustrates the general infrastructure, according to an example implementation.

FIG. 2 illustrates a client-side flow diagram, according to an example implementation.

FIG. 3 illustrates a server-side flow diagram, according to an example implementation.

FIG. 4 illustrates the merging of audio content, according to an example implementation.

FIG. 5 illustrates a representation of audio content matching at some points (origin at the X-axis) and not matching at others, according to an example implementation.

FIG. 6 illustrates a representation of audio content having similar content but no matches, according to an example implementation.

FIG. 7 illustrates the result content: the “average” of all the original sources, according to an example implementation.

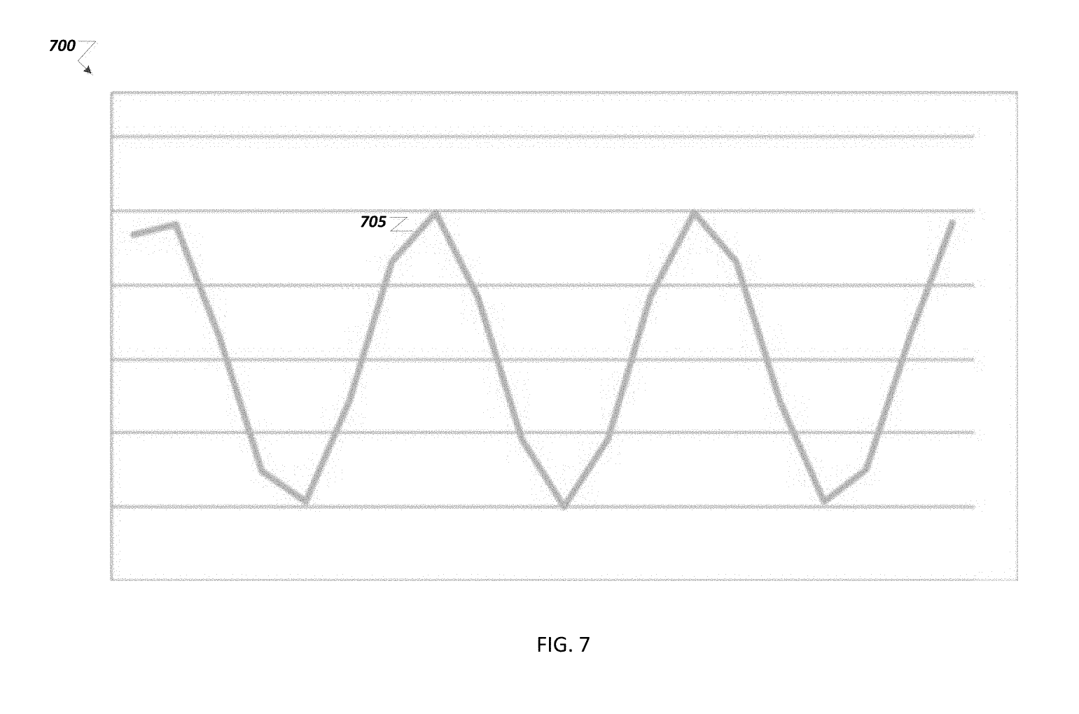

FIG. 8 illustrates an example process, according to an example implementation.

FIG. 9 illustrates an example environment, according to an example implementation.

FIG. 10 illustrates an example processor, according to an example implementation.

### DETAILED DESCRIPTION

The following detailed description provides further details of the figures and example implementations of the present specification. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Key aspects of the present application include processing tagged streams of audio data, identifying patterns within the tagged audio data, merging the audio data into common pieces of content based on the associated metadata, and identifying common points where different pieces can be merged and/or stored as a new entry in a database.

According to some aspects of the example implementations, a process is provided by which one or more users are selected to form a panel of users. Further, each of the selected users on the panel has an online mobile application. The online mobile application provides for online media content to be viewed, as well as for user input to be received. For example, but not by way of limitation, the user input may be received by an audio input that is iteratively refined. The audio input is provided to a server that combines the provided audio input with other files and information. A merged file is generated by the server, that includes common pieces of data between the file received from the online mobile application of the user, and other files of other users as well as historical data. These common pieces of data are integrated into a learning algorithm that provides for improved accuracy and performance with respect to the output.

1. User Selection

Users can select and run the processes, forming a panel 105. A panel is a group of users (e.g., associated with online accounts) with certain qualifications or associations. For example, a panel can be selected for a specific purpose and for a time (e.g., predetermined) that can be disbanded thereafter. Therefore, panelists can be treated as individuals to complete the audio recording process by using a mobile application provided for that purpose.

2. Client Side: Mobile Application

An online mobile application is provided and implemented with the features to facilitate recording streams of sound through an input interface (e.g., microphone). The result can be tagged or edited with metadata and sent to a server 110 and then stored in an audio database 115.

For example, panel members 120 activate a client application that includes modules (e.g., functions) to:

i. Metadata Selection

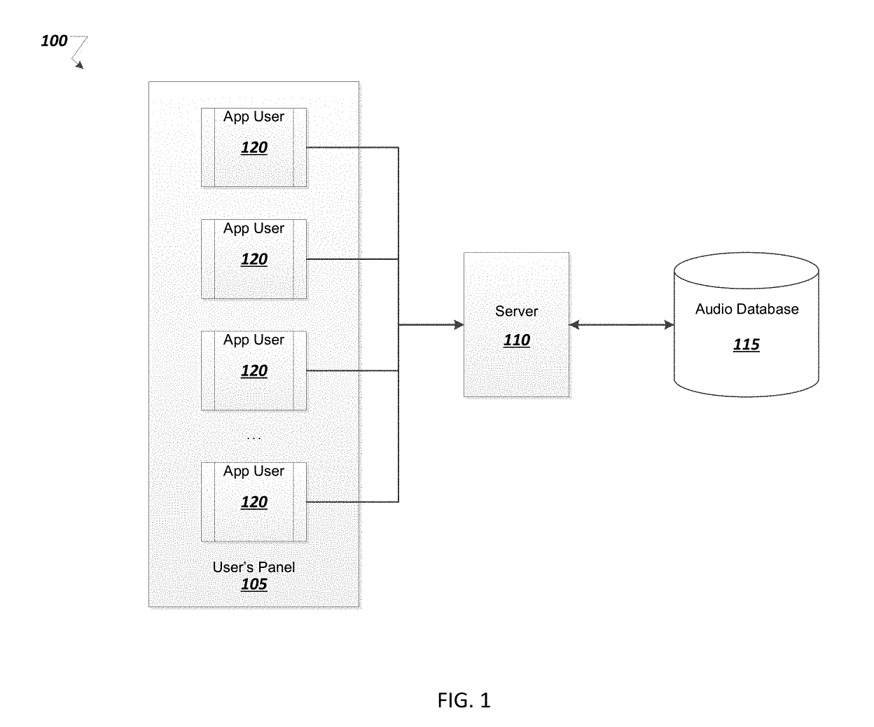

In environment 100, shown in FIG. 1, a screen is provided indicating a type of tagged content 205 or media (e.g., television series, movie, advertisement, television show, etc.). Additional metadata can be configured at the app user panel 105. Each content type can have an associated metadata structure. For example, a television series episode will include information about the episode title, plot, and season and series number, and a television advertisement will include the brand name.

ii. Audio Recording

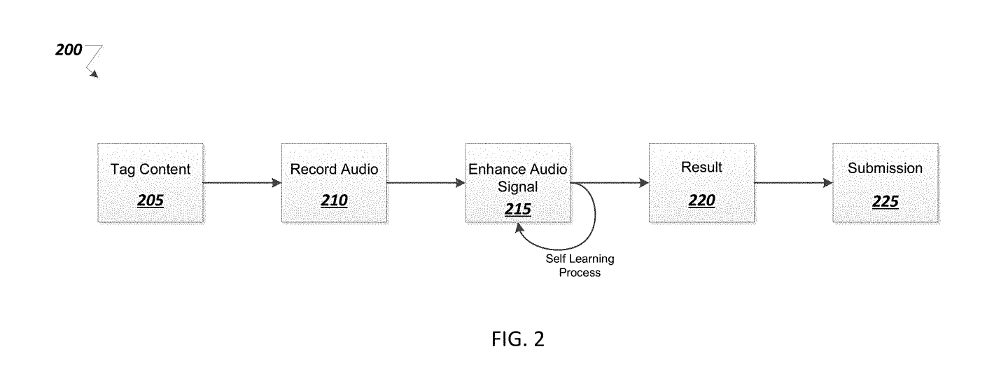

In environment 200, shown in FIG. 2, the user can configure and confirm the metadata. At 210, audio can start recording via an audio input interface. For example, the mobile device on which the application is running can record a stream of media (e.g., audio sound) that is processed locally by the mobile device at 215, including a machine learning algorithm to extract and pre-process based on identifying significant features on the audio signal recorded (e.g., set of frequencies, amplitudes, and phases of the signal). Based on the pre-processing, a cleaner and clearer result signal 220 can be obtained. The information used in this operation is used to identify patterns that will optimize the process on the next iteration of executions. This iteration of executions forms the base of the self-learning process. This operation may be executed in parallel or asynchronously by different clients running the mobile application. The result 220 is then provided to the server in 225.

iii. Submission to the Server

After the recording session has finished (e.g., by a timeout or a user action), the application provides the recorded content and metadata associated to the recorded content to the server through a secure network connection (e.g., HTTP, HTTPS, etc.). The application can complete the process and return to a ready state to start a new session.

3. Server

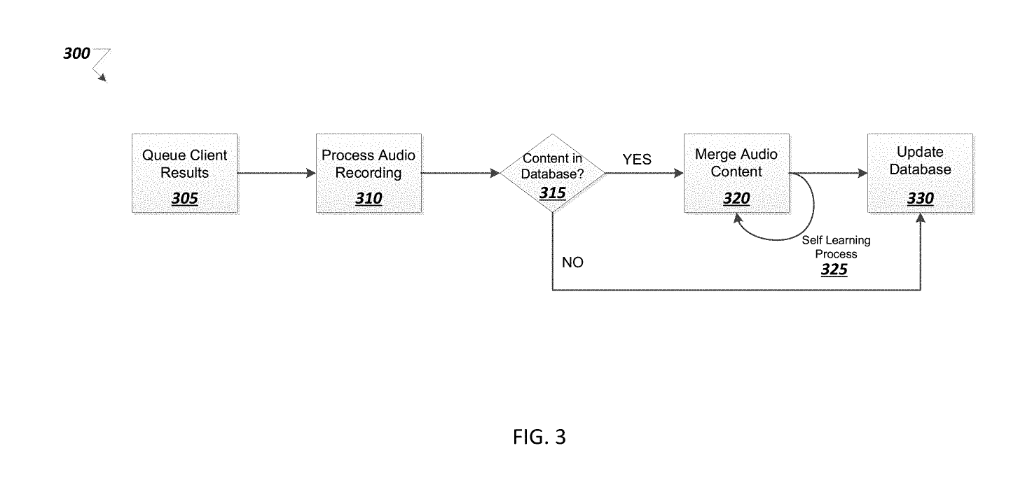

In environment 300, shown in FIG. 3, a central point (e.g., server or group of servers) receives the application's submissions and adds those submissions to a queue 305. When a given submission has reached its turn, that submission is processed at 310 and the submission then gets processed via a new algorithm that will attempt to merge the submission with other audio chunks of the same content, as defined by the associated metadata.

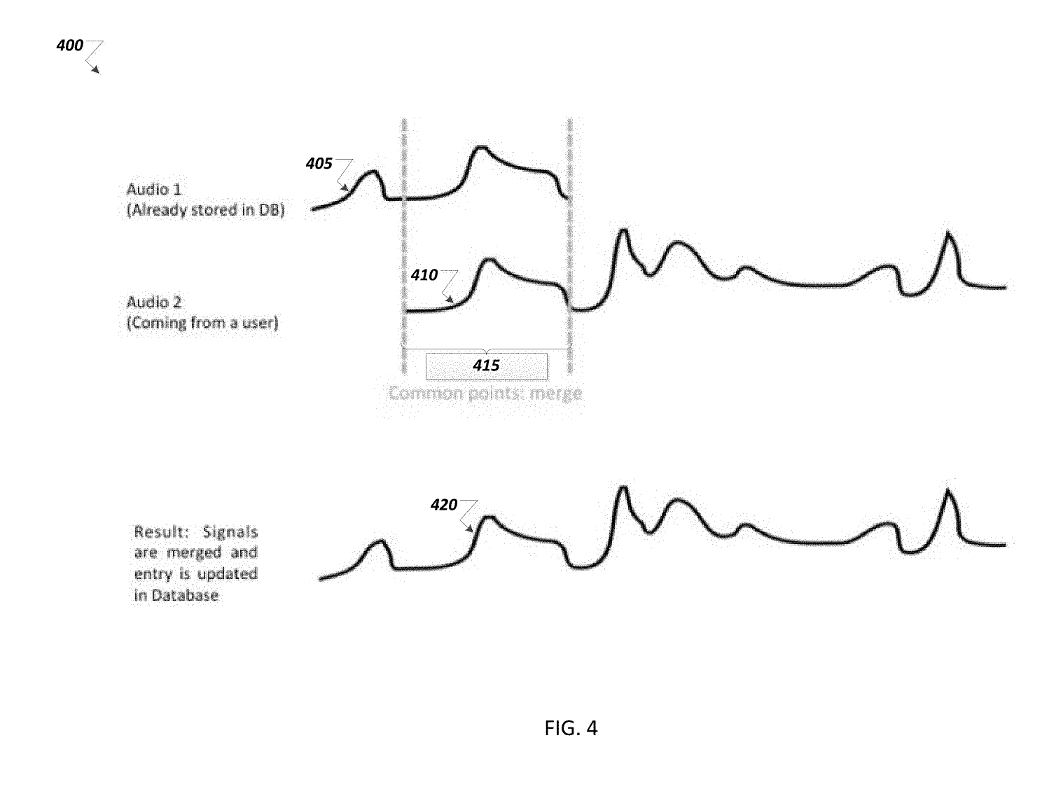

Firstly, at 315, the database is queried to obtain existing pieces 405 of the same content. In the case that the same content does exist, the algorithm will attempt to locate common points 415 between the existing pieces 405 and the new content from the user 410 where the different pieces will be merged at 320 and FIG. 4. Otherwise, a new entry 420 is created and updated at 330 in the audio database 115 for this new content.

Since every recording goes through the same process on the client side, pieces of audio signals are supposed to fit smoothly with those pieces already stored on the audio database 115. However, there may be occasions where some inconsistencies happen. In these cases, the server will apply an algorithm to normalize the problematic pieces, trying to make them fit with the existing entries. The algorithm learns from previous cases and becomes more accurate through each iteration. In order to achieve this, different processes are executed at 325:

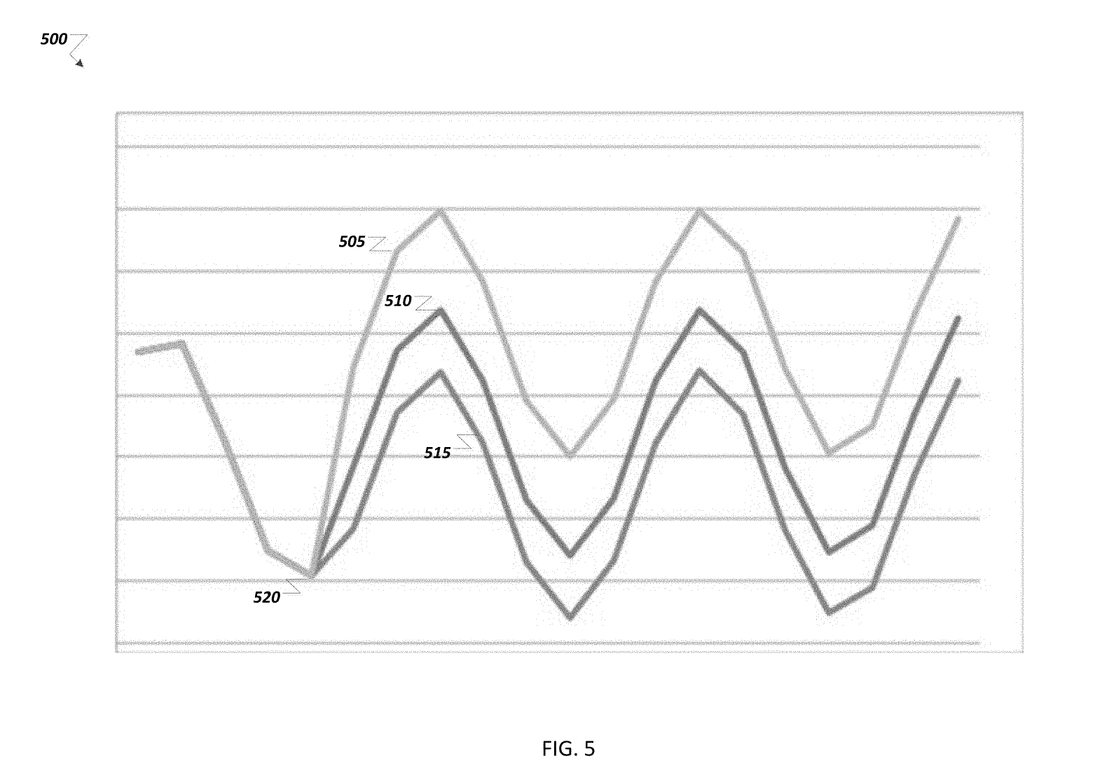

a. As shown in FIG. 5, when different users send pieces of content 505, 510, and 515 that match at some points 520, the algorithm identifies the pieces and attempts to iteratively perform more matches within adjacent positions that were not originally matched, using a lower matching threshold. If a match happens on a particular iteration, the algorithm learns about the pattern(s) that each audio input follows (i.e., how the audio input is affected by noise and/or recording quality based on device conditions or other external conditions).

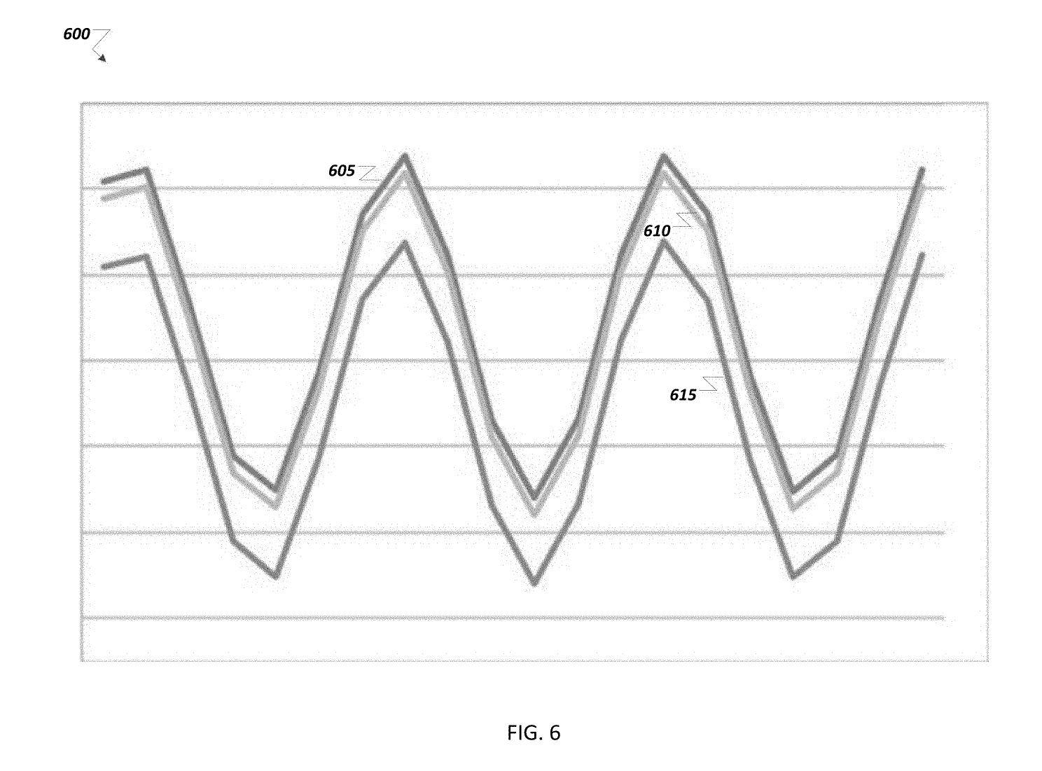

b. As shown in FIG. 6, the same approach is implemented when different audio recordings 605, 610, and 615 present certain similarities but no actual common points. The algorithm will split the signals, compare all the samples, and if the differences remain constant all along the length of the piece analyzed, the algorithm will classify the signals as the same content.

c. As a result of one and/or both of the above processes, the reference signal (i.e., the signal that is used to compare and match future contributions) is processed and transformed into a new version that contains features of the different sources. Every time a new recording matches an existing recording, the reference is recalculated as if that reference were taking the “average” of the original sources, illustrated at 705. This process is executed over the full set of signals.

In order to fully take advantage of the self-learning process performed by the algorithm, each signal modification is saved and linked both to the user and to the device that generated the signal so that certain patterns can be identified and applied in earlier processing (i.e., pre-processing) phases for future contributions. Thus, future recordings will be normalized and will contribute to the enhancement of the database in a more accurate and resource-effective way. Once the matching process has completed, the new entry gets updated 330 in the database 115.

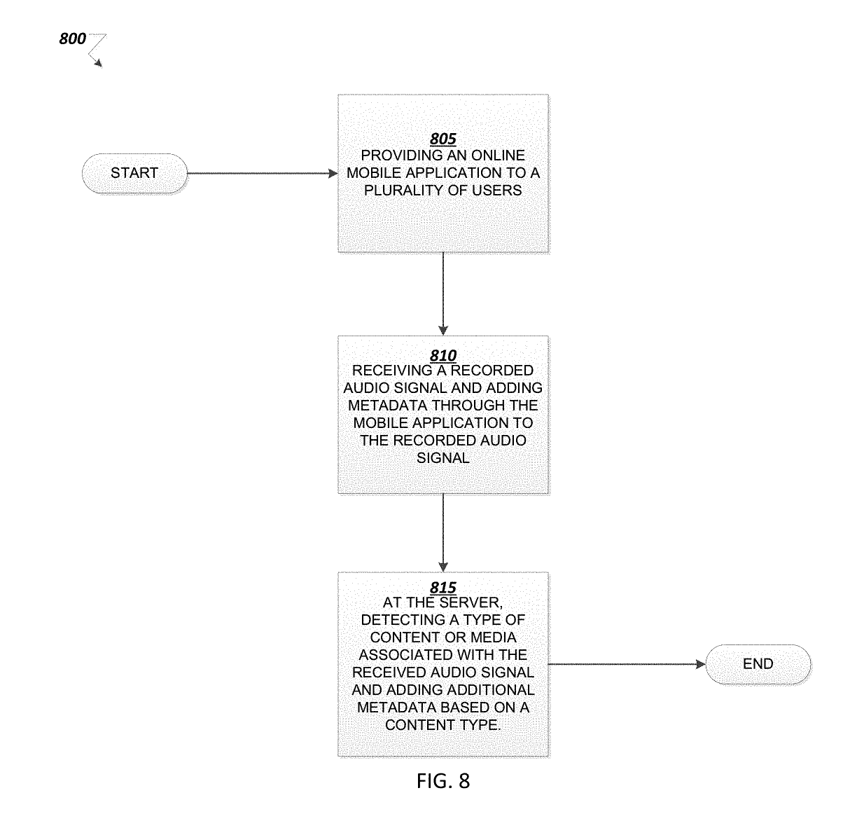

According to an example implementation of a use case, shown in FIG. 8, the following may occur with the present example implementations associated with the inventive concept:

A method comprising:

a. Selecting a panel as a group of people with certain qualifications or associations;

b. In environment 800, providing a mobile application to the panel at 805 to facilitate recording streams of sound through an input interface (e.g., microphone), where the result can be tagged or edited with metadata at 810 and sent to a server, wherein a type of content or media is detected and additional metadata can be configured via the mobile application based on a content type, wherein a content type can have an associated metadata structure at 815.

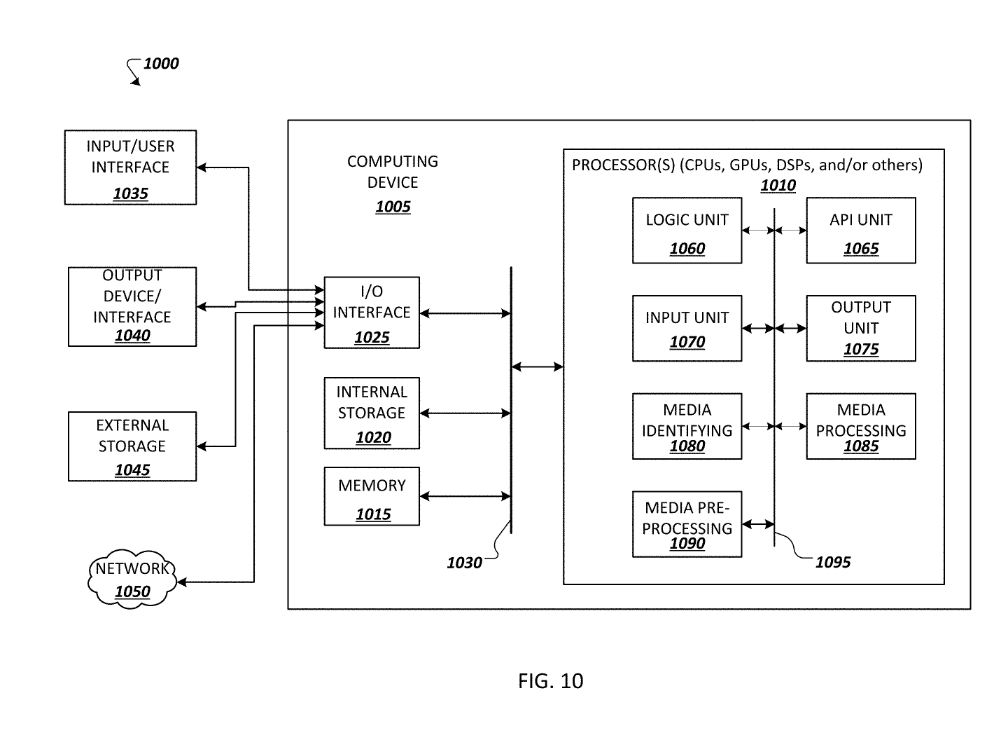

The mobile application has the ability to perform pre-processing, shown in FIG. 10 at 1090, extracting data via a machine learning algorithm based on identifying significant features in the audio signal recorded. Based on the pre-processing, the pre-processed media file is used to identify patterns based in a self-learning process.

In some example implementations, a server application can:

a. Receive the pre-processed media file to identify patterns based on a self-learning process including:

b. Generate a queue of media files from a panel,

c. Merge the media files into common pieces of content based on the metadata,

d. Search a database of existing pieces of the common content, and

e. Identify common points where different pieces can be merged and/or store a new entry created in the audio database 115 for the content.

The server application can determine whether different users send pieces of content that match at one or more points and analyze the matched points for adjacent positions with common characteristics, wherein the common characteristics can be located based on a threshold lower than a matching threshold. In response to a match determination, pattern(s) are directed to a learning module that detects parameters of the media input.

In response to different audio recordings comprising certain similarities without detecting a common point, the server application can further analyze the media to split signals and compare the split signals with samples. If differences remain constant across a length of an analyzed piece of an audio signal, the same content can be considered common content. Further, a reference signal can be selected to use to compare and match additional media files, and the reference signal is processed and transformed into a new version that contains features of the different sources.

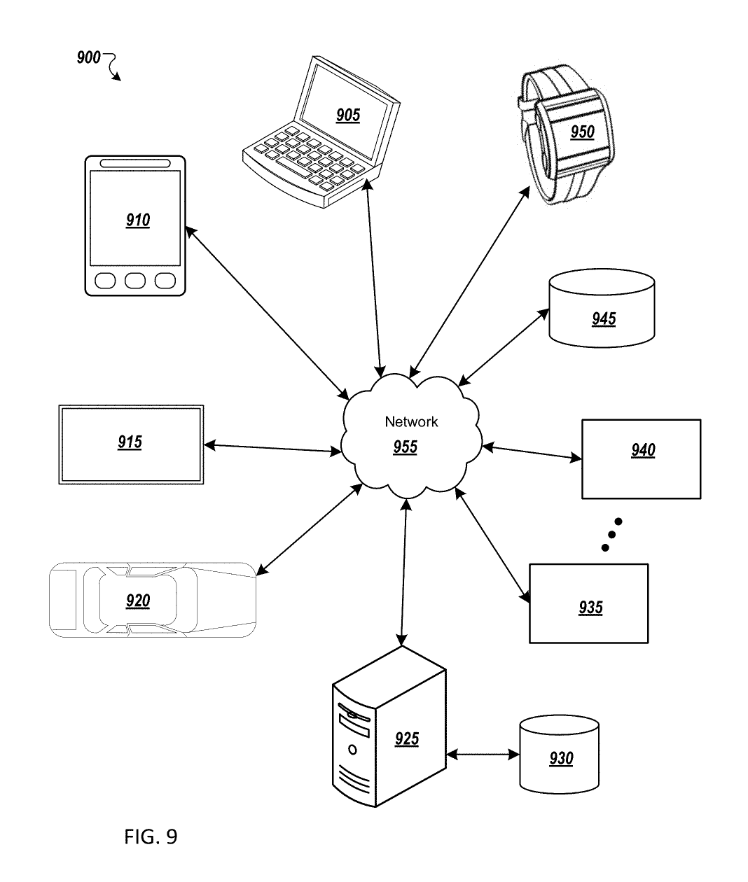

FIG. 9 shows an example environment suitable for some example implementations. Environment 900 includes devices 905-950, and each device is communicatively connected to at least one other device via, for example, network 955 (e.g., by wired and/or wireless connections). Some devices may be communicatively connected to one or more storage devices 930 and 945. Devices 905-950 may include, but are not limited to, a computer 905 (e.g., a laptop computing device), a mobile device 910 (e.g., a smartphone or tablet), a television 915, a device associated with a vehicle 920, a server computer 925, computing devices 935-940, wearable technologies with processing power (e.g., smart watch) 950, and storage devices 930 and 945.

Example implementations may also relate to an apparatus for performing the operations herein. The apparatus may be specially constructed for the required purposes, or the apparatus may include one or more general-purpose computers selectively activated or reconfigured by one or more computer programs. Such computer programs may be stored in a computer-readable medium, such as a computer-readable storage medium or a computer-readable signal medium.

A computer-readable storage medium may involve tangible mediums including, but not limited to optical disks, magnetic disks, read-only memories, random access memories, solid state devices and drives, or any other types of tangible or non-tangible media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

FIG. 10 shows an example computing environment with an example computing device suitable for implementing at least one example embodiment. Computing device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and I/O interface 1025, all of which can be coupled on a communication mechanism or bus 1030 for communicating information. Processors 1010 can be general purpose processors (CPUs) and/or special purpose processors (e.g., digital signal processors (DSPs), graphics processing units (GPUs), and others).

In some example embodiments, computing environment 1000 may include one or more devices used as analog-to-analog converters, digital-to-analog converters, and/or radio frequency handlers.

Computing device 1005 can be communicatively coupled to external storage 1045 and network 1050 for communicating with any number of networked components, devices, and systems, including one or more computing devices of the same or different configuration. Computing device 1005 or any connected computing device can be functioning as, providing services of, or referred to as a server, client, thin server, general machine, special-purpose machine, or another label.

I/O interface 1025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computing device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage) and other non-volatile storage or memory.

Computing device 1005 can be used to implement techniques, methods, applications, processes, or computer-executable instructions to implement at least one embodiment (e.g., a described embodiment). Computer-executable instructions can be retrieved from transitory media and stored on and retrieved from non-transitory media. The executable instructions can be originated from one or more of any programming, scripting, and machine languages (e.g., C, C++, Java, Visual Basic, Python, Perl, JavaScript, and others).

Processor(s) 1010 can execute under any operating system (OS) (not shown), in a native or virtual environment. To implement a described embodiment, one or more applications can be deployed that include logic unit 1060, application programming interface (API) unit 1065, input unit 1070, output unit 1075, media identifying unit 1080, and inter-communication mechanism 1095 for the different units to communicate with each other, with the OS, and with other applications (not shown). For example, media identifying unit 1080, media processing unit 1085, and media pre-processing unit 1090 may implement one or more processes described above. The described units and elements can be varied in design, function, configuration, or implementation and are not limited to the descriptions provided.

In some examples, logic unit 1060 may be configured to control the information flow among the units and direct the services provided by API unit 1065, input unit 1070, output unit 1075, media identifying unit 1080, media processing unit 1085, and media pre-processing unit to implement an embodiment described above. For example, the flow of one or more processes or implementations may be controlled by logic unit 1060 alone or in conjunction with API unit 1065.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices [e.g., central processing units (CPUs), processors, or controllers].

As is known in the art, the operations described above can be performed by hardware, software, or some combination of hardware and software. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or the functions can be spread out across a number of components in any number of ways. When performed by software, the methods may be executed by a processor, such as a general purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as known in the related art, text and mouse (i.e., pointing) actions may be detected and analyzed in video documents. Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A computer-implemented method for generating audio databases for media content, the method comprising:
providing an online mobile application to users that are selected based on one or more qualifications or associations associated with the users;
receiving a recorded audio signal recorded via an interface associated with the mobile application, wherein the online mobile application is configured to add metadata to the recorded audio signal and to provide the recorded audio signal with the added metadata to a server;
at the server, detecting a type of content or media associated with the received recorded audio signal having the added metadata; and
adding additional metadata received from the mobile application provided to the users, based on the type of content or media associated with the received recorded audio signal having the added metadata, wherein the type of content or media associated with the received recorded audio signal having the added metadata is associated with a metadata structure.

2. The method of claim 1, wherein the content type includes one or more of a television series, movie, advertisement, or television show; and
wherein the metadata structure includes additional information about the one or more of the television series, movie, advertisement, or television show, the additional information comprising one or more of title, plot, and brand names for each of the one or more of the television series, movie, advertisement, or television show.

3. The method of claim 1, further comprising:
performing pre-processing on the mobile application by identifying features on the recorded audio signal;
extracting data based on the identified features;
storing the extracted data in a pre-processed media file; and
identifying patterns in the pre-processed media file based on iterative self-learning.

4. The method of claim 3, wherein the iterative self-learning comprises:
generating a queue of media files;
merging the queue of media files into common pieces of content based on the metadata;
searching a database having stored pieces of the common content;
identifying common points where the common pieces and the stored pieces of content can be merged; and
creating and storing a new entry in the database for the content for the common pieces and the stored pieces of content that cannot be merged based on the identifying.

5. The method of claim 4, further comprising:
determining whether different pieces of content match at at least one point; and
analyzing the matched at least one point for adjacent positions with common characteristics;
wherein the common characteristics are located based on a threshold lower than a matching threshold.

6. The method of claim 4, further comprising:
analyzing pieces of content without common points to split signals; and
comparing the split signals with existing pieces of content.

7. A system comprising:
a memory;
a processor operatively coupled to the memory, the processor configured to:
provide an online mobile application to users that are selected based on one or more qualifications or associations associated with the users;
receive a recorded audio signal recorded via an interface associated with the mobile application, wherein the online mobile application is configured to add metadata to the recorded audio signal and to provide the recorded audio signal with the added metadata to a server;
detect a type of content or media associated with the received recorded audio signal having the added metadata; and
add additional metadata received from the mobile application provided to the users, based on the type of content or media associated with the received recorded audio signal having the added metadata, wherein the type of content or media associated with the received recorded audio signal having the added metadata is associated with a metadata structure.

8. The system of claim 7, wherein the content type includes one or more of a television series, movie, advertisement, or television show; and
wherein the metadata structure includes additional information about the one or more of the television series, movie, advertisement, or television show, the additional information comprising one or more of title, plot, and brand names for each of the one or more of the television series, movie, advertisement, or television show.

9. The system of claim 7, wherein the processor is further configured to:
perform pre-processing on the mobile application by identifying features on the recorded audio signal;
extract data based on the identified features;
store the extracted data in a pre-processed media file; and
identify patterns in the pre-processed media file based on iterative self-learning.

10. The system of claim 9, wherein the iterative self-learning comprises:
generating a queue of media files;
merging the queue of media files into common pieces of content based on the metadata;
searching a database having stored pieces of the common content;
identifying common points where the common pieces and the stored pieces of content can be merged; and
creating and storing a new entry in the database for the content for the common pieces and the stored pieces of content that cannot be merged based on the identifying.

11. The system of claim 10, further comprising:
determining whether different pieces of content match at at least one point; and
analyzing the matched at least one point for adjacent positions with common characteristics;
wherein the common characteristics are located based on a threshold lower than a matching threshold.

12. The system of claim 10, further comprising:
analyzing pieces of content without common points to split signals; and
comparing the split signals with existing pieces of content.

13. A non-transitory computer readable medium, comprising instructions that when executed by a processor, the instructions to:
provide an online mobile application to users that are selected based on one or more qualifications or associations associated with the users;
receive a recorded audio signal recorded via an interface associated with the mobile application, wherein the online mobile application is configured to add metadata to the recorded audio signal and to provide the recorded audio signal with the added metadata to a server;
detect a type of content or media associated with the received recorded audio signal having the added metadata; and
add additional metadata received from the mobile application provided to the users, based on the type of content or media associated with the received recorded audio signal having the added metadata, wherein the type of content or media associated with the received recorded audio signal having the added metadata is associated with a metadata structure.

14. The non-transitory computer readable medium of claim 13, wherein the content type includes one or more of a television series, movie, advertisement, or television show; and
wherein the metadata structure includes additional information about the one or more of the television series, movie, advertisement, or television show, the additional information comprising one or more of title, plot, and brand names for each of the one or more of the television series, movie, advertisement, or television show.

15. The non-transitory computer-readable medium of claim 13, wherein the instructions further comprise:
performing pre-processing on the mobile application by identifying features on the recorded audio signal;
extracting data based on the identified features;
storing the extracted data in a pre-processed media file; and
identifying patterns in the pre-processed media file based on iterative self-learning.

16. The non-transitory computer-readable medium of claim 15, wherein the iterative self-learning comprises:
generating a queue of media files;
merging the queue of media files into common pieces of content based on the metadata;
searching a database having stored pieces of the common content;
identifying common points where the common pieces and the stored pieces of content can be merged; and
creating and storing a new entry in the database for the content for the common pieces and the stored pieces of content that cannot be merged based on the identifying.

17. The non-transitory computer-readable medium of claim 16, further comprising:
determining whether different pieces of content match at at least one point; and
analyzing the matched at least one point for adjacent positions with common characteristics;
wherein the common characteristics are located based on a threshold lower than a matching threshold.

18. The non-transitory computer-readable medium of claim 16, further comprising:
analyzing pieces of content without common points to split signals; and
comparing the split signals with existing pieces of content.
